(19) United States
(12) Patent Application Publication
(10) Pub. No.: US 2004/0084904 A1
(43) Pub. Date: May 6, 2004

(54) Obrin power system

(76) Inventor: Obrin Jefferson, Bakersfield, CA (US)

Correspondence Address: Obrin Jefferson, 2601 Fremont Street #83, Bakersfield, CA, 93304-5678, US

(21) Appl. No.: 10/287,045

(22) Filed: Nov. 4, 2002

(51) Int. Cl. H02P 9/04

(52) U.S. Cl. 290/1 R

(57) ABSTRACT

The invention relates to a method and apparatus for creating energy lag time technology by creating and converting multiple energy sources to produce a self-powered generator power supply system with an optional multi zone HVAC/R add-on. An electric starter motor that mechanically turns a generator or alternator that produces the amount of electric energy needed to be transformed into heat (thermal) energy, wherein this heat energy is absorbed by a liquid fluid. Heat energy converting the liquid fluid into a super heated high pressure energy vapor. This super heated pressure energy is then transformed into mechanical energy by means of a rotary turbine. The turbines' mechanical energy is used to turn the generator or alternator producing an electric energy source. The electric energy at this point will have means for stepping up the voltage to a higher output of electric energy needed for operating other electrical and/or electronic devices and applications apart from the system. Part of the higher electric energy output is also directed back into the system where the lower amount of electric energy is needed to produce the heat energy. An expansion chamber in the system superheats the fluid to a vapor state which is then transferred to a primary condenser by its own pressure. This vapor is used by the turbine at a lower pressure and slower rate then it was produced at the expansion chamber. This difference in pressure being used at the turbine creates an energy lag time thereby causing the high pressurized vapor in the primary condenser to act as a energy storage container or fuel tank. After the systems primary condenser reaches a desired high pressure point, the starter will cut off and the generator and/or alternator will be turned by the fluid pressure driven turbine. This forms an energy loop that will maintain a self-powered generator power supply system. It can be used as a sole source of power or part of a unit or application.

### BACKGROUND OF THE INVENTION

The present day forms of creating clean non-polluting electric energy are solar power and wind power. These two sources of power are clean and have an abundant supply. But, the drawback in these power sources is that they are unpredictable due to weather conditions. Also determining the correct geographic location is crucial for achieving optimal performance, this may not be obtainable in many environments or circumstances. However, the main advantage of these two power supply systems is their ability to operate on free energy sources with relatively low maintenance cost for up keep.

The current batteries of today with their higher storage capacity assist both solar and wind powered energy supply systems to overcome unforeseeable weather conditions. With the aid of energy stored in batteries gives solar and wind powered electric generators the ability to deliver a continual source of on going power helping to overcome the hurdle of weather inconsistences. Nevertheless, most people do not have the space nor funds to utilize one of these type of systems for generating their own electric power due to the expanse in which large areas are required for a structural setup. This problem also causes them to lack movement in many instances where mobility is needed.

Other attempts have been made to create power without generating pollutants such as the Sterling engine, but this apparatus lacks feasibility and has extensive limitations. There have also been attempts to utilize the method of converting thermal energy into mechanical energy, but the disadvantage with these and other apparatuses of this type is that they are not regenerative and commonly depend on fossil fuels.

### BRIEF SUMMARY OF THE INVENTION

The present invention relates to a new method and apparatus for creating and converting multiple energy sources into a useable and functional self-powered electric generator power supply system while applying energy lag time technology.

An environmentally clean power supply unit is needed that can produce electric energy while utilizing a very small space. The Obrin power system can be used in a practical way without being bulky or cumbersome. The Obrin power system will provide both mobile and/or stationary capabilities in a smaller packaged unit.

The Obrin power system operates without the drawbacks found in other conventional electric power supply systems, but does have the benefits like; operating on free power (not free only during the start-up mode), portability, dependability and requiring very low maintenance for up keep. It also includes the main added feature of creating an electric power output in a self-propelled operating system.

The compact size of the Obrin power system with energy lag time (ELT) technology makes it a very effective and beneficial electric power supply unit that can have a wide variety of uses in many applications.

Energy lag time is the utilization of the gap in time before full energy depletion takes place at a predetermined location in the system. This gap in time being created by both slow dissipating and fast depleting energies which are produced within the self-propelled unit enables the power supply system to form an energy loop, thereby producing a regenerative electric generating power supply which is the Obrin power system. A more detailed explanation on this subject in the technical field section.

### TECHNICAL FIELD

Method of Energy Lag Time (ELT) explained:

1. The ability to change or switch the systems' energy starting point thereby creating a self-propelled power supply. 2. Creating a delay in time before full energy depletion takes place at a predetermined point in the system. 3. Utilizing the delay in time created before full energy depletion takes place at the predetermined point in the system, so that at a different planned location additional energy is being produce by the system, thereby providing the means for the self-powered electric generator to empower itself and other devices and/or applications.

Energy lag time technology will produce a continuous source of power. In this self powered unit, before energy lag time, the systems starting point will occur at the electric energy producing device where it will produce the electric energy output required for the start-up operation. See below for energy conversion sequence;

System sequence before energy lag time (ELT), during start-up mode

1. Electric energy (original starting point)

2. Heat energy (thermal dynamic energy)

3. Pressure force

4. Mechanical energy

5. Electric energy (back to the original starting point, forming an energy loop)

System sequence operating in energy lag time (ELT), now in run mode

1. Pressure force (becomes new starting point)

2. Mechanical energy

3. Electric energy

4. Heat energy (thermal dynamic energy)

5. Pressure force (back to the said new starting point, forming an energy loop).

The energy conversion sequence is not limited to the order in which it is presented and listed above, energy conversions can be arranged in any number of configurations to produce energy lag time results. The list above is one example arrangement of energy transformation for constructing an energy loop.

Energies dissipate their potential at different rates in time and in speed, therefore electric energy from a generator can deplete its power very quickly in comparison to a liquid that can store heat energy (thermal dynamic) for longer periods. Depending on what mediums are used to store this heat energy and the release rate at which this heat energy will be depleted from the medium, also the mechanical device being utilized and how efficiently it can operate will determine the performance of the overall self-powered electric generating power supply system (Obrin power system).

Liquid refrigerant has the ability to become superheated at a low temperature and then transform into a very high pressurized vapor, this greatly controls the amount of energy lag time a system can maintain. When the high pressurized vapor is being utilized by a rotary turbine at a slower rate and lower pressure then it is generated at the expansion chamber produces a difference in pressure. This difference in pressure creates an energy lag time making the primary condenser function as a reservoir or storage tank filled with a high pressurized vapor containing energy potential.

An example of this technology shows that if a turbine is utilizing the high pressurized refrigerant vapor accumulated in the primary condenser at a rate of less than 90 pounds per square inch (rotary turbine operating at 90 psi maximum), whereas the minimum operating pressure that will be predetermined of no less than 200 pounds per square inch at the primary condenser (a minimum operating pressure of 200 psi at the primary condenser) will create a delay in the time that it will take before the high pressure and thermal energy accrued in the primary condenser to fully deplete.

By utilizing this interval or gap in time, before full energy depletion can occur at the primary condenser creates a window of opportunity for the Obrin power system to generate the additional electric energy needed to empower itself and replenish the primary condenser with superheated pressurized vapor. By keeping the primary condenser at optimal pressure conditions enables the Obrin power system to maintain operation and form an energy loop.

Also, this same additional electric energy will be increased to a higher voltage output by means of a step-up transformer or the like, so that the self-powered electric generator power supply system will have extra electric energy to support and provide for other devices and/or applications outside of the system (Obrin power system).

It is understood that a prolonged energy depletion rate at the primary condenser by use of an efficient rotary turbine will produce more energy lag time thereby achieving a system operating with a greater rate in performance. By using various arrangements of devices, fluids and materials will allow for different combinations that can create differing times in energy depletion rates which will determine the performance of the self-powered electric generator power supply system (Obrin power system). Note that the system will have means for cycling itself automatically.

When the expandable fluid in the system is superheated to a vaporized state and reaches the desired high pressure point needed for maintaining operation of the self-powered electric generator power supply system, the electric starter motor powered by means of a on board direct current (DC) battery source or an alternating current (AC) source from an outside or remote location will cut off and the high pressurized vapor from the primary condenser will maintain the systems' operation and also become the units' new energy starting point.

A halt in the flow of expandable refrigerant fluid just before the rotary turbine machine will stop the mechanical process and/or a break in the electric energy supplied to the direct superheating element at the expansion chamber will perform a result in shutting down or powering down the Obrin power system (self-powered electric generator power supply system).

By increasing the electric energy output to a higher voltage output with the use of a transformer or the like will give the Obrin power system the ability to provide electric energy which can be utilized by a multiple of electrically operated devices and/or applications externally of the system. A portion of this higher voltage output will be use to power the expansion chamber, pump and other devices within the power supply system as needed for maintaining self operation thereby making this a regenerative unit.

While the present invention has been illustrated with reference to particular embodiments thereof, it will be understood that various modifications can be made by those skilled in the art without actually deviating from the scope of the invention. Therefore, all modifications and equivalents may be resorted to which fall within the scope of the invention as claimed.

### DETAILED DESCRIPTION OF THE INVENTION

Title of the Invention: Obrin Power System

This invention will now be described in more detail referring to attached drawings. Note that all arrows depicted in drawings show the direction of fluid flow.

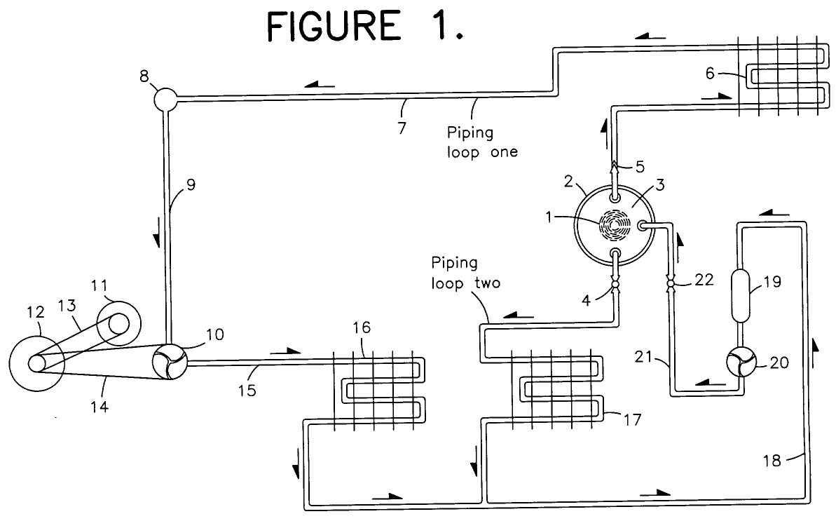

FIG. 1. shows the embodiment of the invention. The starting point is at the electric starter motor 11 which drives the electric energy producing device 12 by means of a rotational energy connecting element 13. The starter motor 11 will have enough torque to get the system up and running so that the fluid driven rotary machine 10 will not have to start under load conditions.

The electric energy producing device 12 will provide the electric energy that will be used to power the direct superheating element 1, fluid transferring device 20 and automatic valves 4 and 22.

The automatic valves 4 and 22 are normally in the close position and will open to allow expandable fluid 3 pumped from the receiver 19 by means of the fluid transferring device 20 to enter the expansion chamber 2. Super heating the expandable fluid 3 will take place by means of the direct superheating element 1. Most of these items are electrically powered devices.

The electric energy means to energize these devices will be provided by the start up operation of the starter motor 11, rotational energy connecting element 13 and the electric energy producing device 12. The electric power provided to the starter motor 11 will come from an alternating current (AC) outside power source and/or a on board direct current (DC) battery power source.

Once the expansion chamber 2 is filled to the desired level with expandable fluid 3, the fluid transferring device 20 will stop pumping expandable fluid 3 and the automatic valves 4 and 22 will close back to their normally close position trapping the expandable fluid 3 inside a gas tight hermetic casing (called the expansion chamber 2).

The liquid expandable fluid 3 is now prepared to be superheated to a high pressure vapor induce by the direct superheating element 1. Once the expandable fluid 3 is superheated to a vapor state, the force from this pressurized vapor will cause the expandable fluid 3 to expand and evacuate the expansion chamber 2 by way of an outlet tubing connected to a check valve 5.

The check valve 5 is used to allow fluids to flow in only one direction so that the fluid moves forward and prevents it from reversing or backing up.

All the liquid expandable fluid 3 inside the expansion chamber 2 will be boiled or expanded to a complete vapor state. The expandable fluid 3 now leaving the expansion chamber 2 has now changed from a low pressure liquid into a high pressurized vapor and will advance itself inside the tubing and arrive at the primary condenser 6.

The high pressurized expandable fluid 3 in the primary condenser 6 will travel down stream by means of tubing 7 and will decelerated by means of a adjustable pressure regulator 8.

The function of the adjustable pressure regulator 8 will be to allow a desired amount of expandable fluid 3 flow, by reducing the pressure and flow creates a controlling means for the amount of energy available to be used by the rotary machine 10. The high pressurized expandable fluid 3 within tubing 7 will be decreased at the point of the adjustable pressure regulator 8 so that it will now be at a considerably lower pressure within the tubing 9.

The expandable fluid 3 now adjusted and calibrated to a lower pressure inside tubing 9 will flow down stream to provide the energy needed to propel the rotary machine 10, thereby causing the rotary machine 10 to rotate at the proper speed and force required to mechanically turn the electric energy producing device 12 by means of a rotational energy connecting element 14.

As stated in the technical field section entitled Method of Energy Lag Time explained:, clarifies this principle which applies to the components that will produce this technology. The turbine being a rotary machine 10 will operate on a limited amount of the high pressure expandable fluid 3 within the primary condenser 6. This will permit the energy lag time allowing for a slower rate of energy depletion within the primary condenser 6. This effect will cause the primary condenser 6 to have a surplus of energy to be utilized by the system, thereby making it become the systems' new energy start point.

The expandable fluid 3 upon entering and leaving the rotary machine 10 producing the mechanical energy needed to turn the electric energy producing device 12 will travel down stream by means of tubing 15 where it will enter the secondary condenser 16.

The expandable fluid 3 will now be under even lower pressure conditions inside the secondary condenser 16 so that the expandable fluid 3 may condense back into a liquid state for system reuse. Once the expandable fluid 3 condenses into a liquid, it will travel down stream by means of tubing 18 and be stored in the receiver 19 so that the liquid expandable fluid 3 will be ready for reuse by the fluid transferring device 20.

This is what's known as piping loop one, the loop providing the energy needed to operate the self-powered electric generator power supply system (Obrin power system) and other devices and applications.

The purpose of the piping loop two is to provide both pressure relief of the expansion chamber 2 and to reduce the load against the fluid transferring device 20 throughout the filling and refilling cycle.

As both automatic valves 4 and 22 open, automatic valve 4 will allow the remaining vapor inside the expansion chamber 2 to escape and enter the recycling condenser 17 so that the expandable fluid 3 in its vapor state can be condensed back into a liquid for reuse. It to will travel by means of tubing 18 and be stored inside the receiver 19 so that it will be ready for system reuse.

This ends the detail description for FIG. 1.

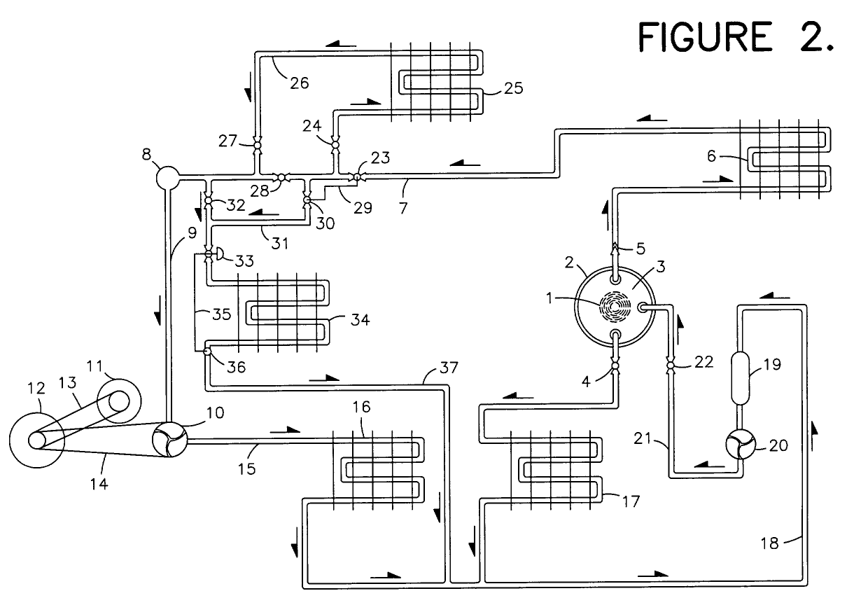

FIG. 2. shows all the same components of FIG. 1., but with the addition of the heating, ventilation and air conditioning or refrigeration add-on to produce a standalone climate control system.

The starting numbers are the same from 1 through 22 of FIG. 1., FIG. 2. has the addition of 23 through 37. The system operates in the same fashion but with an add on.

Heating Cycle of the Unit;

Automatic valves 24 and 27 are normally in the closed position until the heating cycle is requested. The automatic valves 24 and 27 will open to allow expandable fluid 3 to travel by means of tubing 7. The superheated expandable fluid 3 will have a high heat content when entering the heating coil (heat exchanger) 25 by way of automatic valve 24 now in the open position.

The expandable fluid 3 upon leaving the heating coil 25 will travel by means of tubing 26 entering automatic valve 27 still in the open position where the expandable fluid 3 will now enter the adjustable pressure regulator 8.

During this operation the automatic valve 28 which is normally in the open position for expandable fluid 3 flow will close so that all the superheated expandable fluid 3 leaving the primary condenser 6 traveling by way of tubing 7 will enter the heating coil 25.

Cooling Cycle of the Unit;

When the air condition is called upon for cooling, automatic valve 32 will open to permit superheated expandable fluid 3 to flow forward to the thermal expansion valve (TXV) 33 and then enter the cooling coil (heat exchanger) 34.

The temperature sensing element 36 is connected to the tubing just after the cooling coil 34. The connection link 35 is part of the thermal expansion valve (TXV) that detects the temperature of the expandable fluid 3 leaving the cooling coil 34.

The expandable fluid 3 after leaving the cooling coil 34 and flowing past the sensing element 36 will now travel down stream into tubing 37 and proceed to tubing 18 until it approaches the receiver 19 so that it will be ready for system reuse.

Note: Both heating and cooling cycles do not operate at the same time.

The high pressure sensing element 23 is a safety device for detecting extreme pressures. The automatic valve 30 is normally closed and will open if extreme pressure is detected at the sensing element 23. The connection 29 links the sensing element 23 to the automatic valve 30 which will allow tubing 31 to act as a bypass to prevent the system from being over pressurized.

This ends the detail description for FIG. 2.

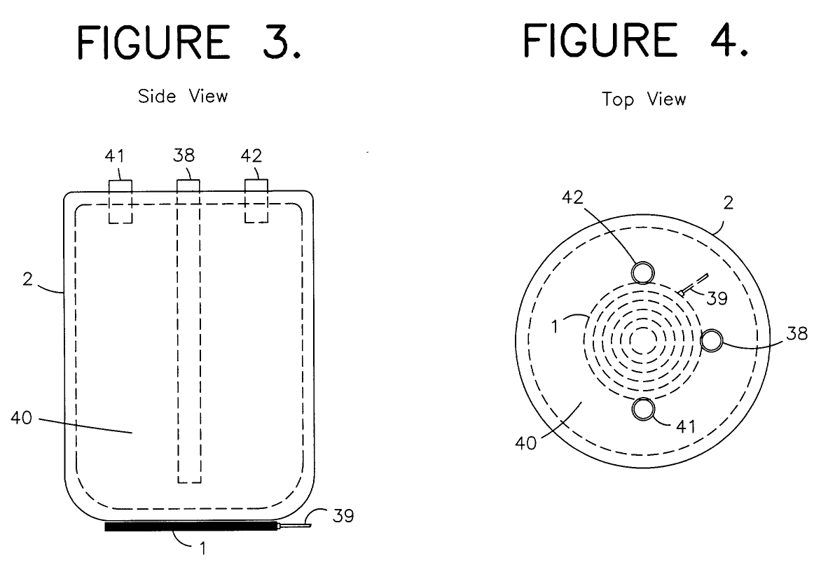

Note: FIG. 3. and FIG. 4. illustrate the expansion chamber 2 in more detail, also note that the expandable fluid 3 in FIG. 1. and FIG. 2. refers to the fluid used by the system and that in FIG. 3. and FIG. 4. the internal housing 40 refers to the hermetic inside casing compartment of the expansion chamber 2.

FIG. 3. illustrates the side view of the expansion chamber 2 while FIG. 4. illustrates the top view of the expansion chamber 2. The expansion chamber 2 contains a hollowed internal housing 40 built to withstand high pressure and high temperatures from the superheated expandable refrigerant fluid or the like.

The expansion chamber 2 has three tubing connections total, two tubing outlets and one tubing inlet. The outlet tubing 41 is the relief outlet used for extracting the remaining high pressure vapor from the internal housing 40 of the expansion chamber 2 during the filling and refilling cycle so that the unused vapor can be condensed and recycled for reuse. The outlet tubing 42 is the vapor discharge outlet used for releasing the usable superheated vapor into the system for use of its high pressure and thermal energy. The one inlet tubing 38 is used for filling and refilling means.

The one inlet tubing 38 provides access for the liquid refrigerant or the like to enter the internal housing 40 of the expansion chamber 2.

The direct superheating element 1 is utilized to swell or expand the refrigerant or the like and cause it to go from a liquid state to a superheated vapor state inside the internal housing 40 of the expansion chamber 2.

The direct superheating element 1 is an electrically powered device.

The connection 39 is a connecting means for allowing electric energy to flow to the direct superheating element 1. The internal housing 40 is where the expansion of the liquid refrigerant will take place. The expansion chambers' 2 internal housing 40 is a leak free hermetically sealed container.

This ends the detail description for FIG. 3. and FIG. 4.

I claim:

1. A method for creating energy lag time within a power supply system comprising:
(a) an apparatus containing a plurality of energy converting devices with means for permitting a selected energy from amongst a plurality of energies that are produced within a power supply system to be utilized at a prolonged extended pace of energy depletion at a predetermined location in said power supply system, thereby causing said selected energy to establish a surplus at a different planned location within said power supply system, so that the energy surplus produced is utilized internally by said power supply system to:
(1) maintain system operation, and
(2) create an energy loop;
(b) said apparatus further containing a energy conserving device with means for permitting said selected energy from amongst a plurality of energies that are produced within said power supply system to be utilized at said prolonged extended pace of energy depletion at said predetermined location in said power supply system, thereby causing said selected energy to said establish a surplus at said different planned location within said power supply system, so that said energy surplus produced is utilized internally by said power supply system to:
(1) aid in said maintaining system operation, and
(2) aid in said creating an energy loop;
(c) means for changing the energy starting point of said power supply system, thereby:
(1) said aiding in said creating an energy loop, and
(2) sustaining said energy loop;
(d) means for creating an interval in the time that it will take before energy consumption can occur at a predetermined point in said power supply system, so that said power supply system utilizes said interval to empower itself.

2. An apparatus for creating and converting multiple energy sources into a self-powered electric generator power supply system comprising:
(a) said method for creating energy lag time within a power supply system in accordance to claim 1;
(b) a hermetic casing in sufficient quantity with means for providing fluid super heating vaporization duties;
(c) means for said hermetic casing connected to a piping loop one, a piping loop two respectively joined together with other devices to form a hermetically sealed circuit;
(d) means of a liquid expandable fluid being able to vaporize, having a sensitive reaction to:
(1) change in temperature, or
(2) change in pressure;
(e) said expandable fluid within said hermetically sealed circuit;
(f) said hermetic casing providing means for super heating said expandable fluid to a high pressure vapor having high heat content, thereby generating power to do work;
(g) three heat exchanger condensers forming three different stages referred to as:
(1) a primary condensing stage,
(2) a secondary condensing stage, and
(3) a recycling condensing stage, wherein having means for condensing said super heated high pressurized expandable fluid for reuse within said hermetically sealed circuit;
(h) a fluid transferring device providing fluid relocating means in said hermetically sealed circuit;
(i) means of an electric energy producing device in sufficient quantity which utilizes mechanical energy to dispense electric energy;
(j) means of a rotary machine which utilizes said super heated high pressure expandable fluid to provide said mechanical energy, thereby supplying the force needed to energize said electric energy producing device;
(k) means of a pressure regulating device for permitting a predetermined amount of said super heated high pressure expandable fluid flow, thereby providing an acceptable measure of power required to energize said rotary machine;
(l) said rotary machine having a connection to said electric energy producing device by means of a rotational energy connecting element;
(m) means of a voltage output increasing device to:
(1) increase the voltage output of said electric energy producing device, thereby providing a higher voltage output with sufficient power to be utilized internally by said self-powered electric generator power supply system, and
(2) increase the voltage output of said electric energy producing device, thereby providing a considerable said higher voltage output for external utilization;
(n) said external utilization providing electric energy accessibility means for:
(1) one device, or
(2) a plurality of devices;
(o) a system controlling device providing:
(1) means of a start-up mode, thereby producing initial system activation of said self-powered electric generator power supply system which will be operating without the method of said energy lag time,
(2) means of a run mode, so that said self-powered electric generator power supply system will be operating with the method of said energy lag time, and
(3) means for mode switching;
(p) means for powering down said self-powered electric generator power supply system, thereby switching said self-powered electric generator power supply system from operating to off;
(q) means for joining said piping loop one, said hermetic casing and said piping loop two with other said devices to work collectively to produce said energy lag time, thereby constructing a operational regenerative electric generating power emitting unit.

3. A stand-alone climate control apparatus comprising:
(a) said apparatus for creating and converting multiple energy sources into a self-powered electric generator power supply system in accordance to claim 2, further including;
(b) means of a ambient air conditioning temperature control function incorporating:
(1) a evaporator heat exchanger with means for cooling ambient air, and
(2) a condenser heat exchanger with means for heating said ambient air;
(c) means for joining together said ambient air conditioning temperature control function to said piping loop one and said expandable fluid to form said hermetically sealed circuit.

4. The apparatus for creating and converting multiple energy sources into a self-powered electric generator power supply system set forth in claim 2, wherein said hermetic casing is a expansion chamber comprising:
(a) a hermetically sealed leak resistant casing able to withstand:
(1) various temperatures, and
(2) high pressure, whereby a method for super heating said liquid expandable fluid to a super heated high pressurized usable vapor having high heat content can take place;
(b) said expansion chamber further incorporating:
(1) a first tubing outlet,
(2) a second tubing outlet, and
(3) a one tubing inlet;
(c) said first tubing outlet having a check valve connection with means to prevent said super heated high pressurized usable vapor from reversing upon discharge of said expansion chamber;
(d) said second tubing outlet having a valve connection;
(e) said one tubing inlet having a valve connection;
(f) said second tubing outlet providing pathway means for discharge of unused said super heated high pressurized vapor fluid;
(g) said one tubing inlet providing pathway means for said expandable fluid to enter said expansion chamber;
(h) a direct superheating device located in a convenient manner of said expansion chamber;
(i) said direct superheating device is an electrically powered apparatus providing means for said fluid super heating vaporization duties.
